(19) United States
(12) Patent Application Publication
(10) Pub. No.: US 2009/0254357 A1
(43) Pub. Date: Oct. 8, 2009

(54) COMPUTER-IMPLEMENTED METHOD AND SYSTEM FOR ANALYZING OPERATING COSTS OF BATTERY-OPERATED SHEET DISPENSERS

(75) Inventor: EDWARD T. GISSKE, Mt. Horeb, WI (US)

Correspondence Address: YOUNG & THOMPSON, 209 Madison Street, Suite 500, ALEXANDRIA, VA, 22314, US

(73) Assignee: SCA TISSUE NORTH AMERICA LLC, Neehah, WI (US)

(21) Appl. No.: 12/098,471

(22) Filed: Apr. 7, 2008

(51) Int. Cl. G06Q 99/00

(52) U.S. Cl. 705/1

(57) ABSTRACT

Expected battery consumption by non-hard wired paper towel dispensers is calculated and compared as a way to help sell dispensers. The information is provided on a real-time basis not only for each type of dispenser a salesperson is attempting to sell, but also for competitive dispensers so that the customer can make an informed decision as to which dispenser(s) best meets his needs.

### FIELD OF THE INVENTION

The invention relates to computer-implemented method and system for analyzing operating costs of products in general, and preferably battery-operated sheet dispensers.

### BACKGROUND OF THE INVENTION

The sheet dispensing apparatus market is very competitive, and profits are based on sales volume. In some cases, a dispenser manufacturer will lease the dispenser itself to a customer free of charge and then provide the customer replacement rolls of dispensable sheet material, so that the profit in such cases comes from selling the user replacement rolls.

Each manufacturer typically has a proprietary product line in which only rolls designed for a particular dispenser can be used with that particular dispenser. Nevertheless, the dispenser products are functionally very similar and the cost of one manufacturer's rolls is comparable to another's and thus, it is often features other than the appearance of a particular dispenser or the rolls dispensed therefrom that will enable a salesperson to sell that particular dispenser to a customer. Accordingly, any way in which a customer can see a direct advantage over a competitive product would make that customer more likely to buy one product over another.

One advantage the customer is interested in is the efficiency of the dispenser. As most modern day sheet dispensers are battery operated, this efficiency is largely based on battery consumption. Batteries are expensive, and a dispenser that is more efficient in terms of battery usage will be more appealing to a customer than a competitive dispenser, other factors aside.

### SUMMARY OF THE INVENTION

An object of the invention is to provide prospective purchasers of battery-operated products with customized computer-generated information as to expected battery use, in the context of proposing the sale of such products to the customer. This information may be provided not only for each type of product or dispenser the salesperson is attempting to sell, but also for competitive dispensers so that the customer can make an informed decision as to which dispenser(s) best meets his needs.

### BRIEF DESCRIPTION OF THE DRAWING

FIG. 1 is a flow chart showing various steps of a first embodiment of the invention.

### DETAILED DESCRIPTION OF THE PREFERRED EMBODIMENTS

As noted above, batteries are a major operating expense for battery-powered apparatus such as absorbent sheet dispensers. That cost includes not only the cost of the batteries themselves, but also the cost of having a maintenance person replace the battery. A further hidden cost is in lost or dissatisfied customers that are unable to dry their hands due to the batteries being dead and the dispenser not operating.

Preferred embodiments of the invention are able to minimize or eliminate the dispenser down time by providing an estimate of battery life so that the user can be made aware of when his batteries are likely to go dead.

In preferred embodiments of the invention, a dispenser manufacturer or distributor provides its salespeople with a computer software program or a pre-programmed computer, preferably a notebook computer for ease of use in the field, that is able to perform a calculation of battery-based operating costs, as well as preferably a comparison of such costs in relation to various competitive dispensers.

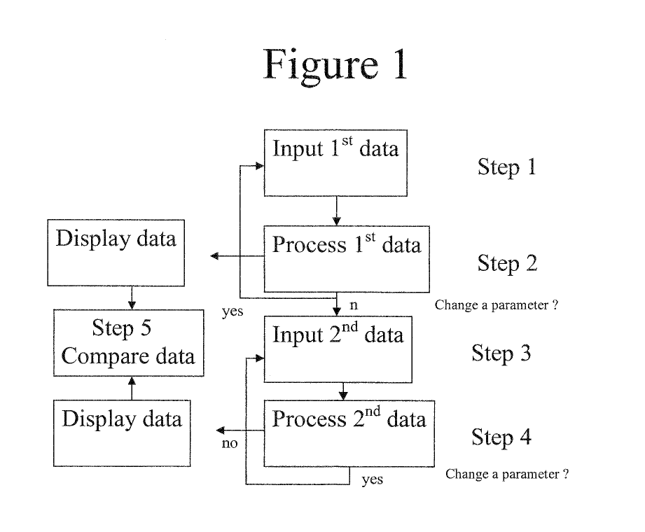

As seen in FIG. 1, various inputs are received at step 1. These inputs are based on data known by the salesperson and/or the customer.

These inputs may include: 1) the length of a roll of paper towel received by dispenser A (usually expressed in feet, but metric or other units can be input) and 2) a length of a sheet that is dispensed by the dispenser A, usually expressed in inches, but again the dimensions are only meant to be exemplary and are not limited to any particular unit. The sheet length is usually entered for rolls having perforated sheets of a uniform length. However, non-perforated sheets could also be used and either an estimated sheet length would be used or this data may be determined by a controller on the dispenser.

Additional data to be input may include: 3) number of rolls used per year and 4) battery capacity, usually expressed in ampere-hours (Ah).

Most modern day dispensers include a battery saving feature that allows the dispenser to enter a “sleep mode” or “standby mode” wherein the current supplied to the dispenser is reduced from the current being supplied during an “awake mode” or operating/dispensing mode. If a dispenser having a battery saving feature is being used, the following parameters may also be input: 5) sleep current, usually expressed in microamperes (μA); 6) sleep time, usually expressed in milliseconds (mS); 7) awake current (μA); and 8) awake time (mS).

In addition, regardless of the type of dispenser being used the following parameters may also be input: 9) average dispense current (mA) and 10) dispense time in seconds.

A computer software program processes the input parameters at step 2 and displays the processed input as output on a display screen. The display may include an intermediate output result, which shows output data such as: 1a) number of sheets per roll; 2a) number of sheets used per month; 3a) number of sheets used per day; 4a) number of sheets used per year; 5a) the energy required to dispense one sheet, usually expressed in milliamp-hours (mAh).

If the dispenser has a battery saver feature, additional intermediate outputs may include: 6a) energy used per month in standby mode (aH); 7a) energy used per month to dispense (aH).

Additional intermediate outputs may also include: 8a) percent of energy used to move paper (%); 9a) percent of energy used while waiting (%) and 10a) average standby current (μA).

As part of the processing during step 2, a final output result is also displayed in the display. This result is preferably battery life, usually expressed in months.

Various input parameters may then be changed to see how these parameters affect battery life.

In step 3, the input parameters are input for a different dispenser, whether that dispenser is a competitor's dispenser or a different unit sold by the same manufacturer. A salesperson, for example, may input parameters of an older dispenser, so that the user can see why he should upgrade his dispenser to a newer model, or to compare different types of dispensers from the same manufacturer.

In step 4, the input parameters for the different dispenser are processed and displayed as output parameters on a display screen. Again, some of the input parameters may be changed to see the effect on the output parameters.

In step 5, the user makes a comparison of the output data in order to assist the customer in making an informed decision as to which dispenser best meets his needs.

The output data from step 2 may be printed for comparison with the output data in step 4 or, part or all of the output data from step 2 may be shown on the display screen adjacent to the output data displayed in step 4 so that the customer can perform a side-by-side comparison of the data.

The process according to the invention need not compare one product to another, whether by the same or different manufacturers. Instead, it will be apparent that the process could terminate after step 2 described above, with the calculated result being used to determine how many dispensers should be purchased based on the frequency with which the customer desires or is willing to change the batteries.

Although the term “battery” and “batteries” are used throughout the specification, these terms are used interchangeably and the present invention is not limited to a single battery or any type of battery and is intended to cover a single battery as well as plural batteries, including disposable and rechargeable batteries.

The invention has been described in detail with respect to preferred embodiments. However, it will be appreciated by those having ordinary skill in the art that changes or modifications may be made without departing from the spirit of the invention. The invention should not be limited to the embodiments disclosed and should be defined by the appended claims.

What I claim is:

1. A computer implemented method of comparing a first product offered for sale by a first source to a second product offered for sale by a second source, the first and second sources being in commercial competition with one another, comprising:
inputting into a digital computer data representing expected usage of said first product by a prospective customer;
inputting into the digital computer data representing expected usage of said second product by a prospective customer;
processing said data pertaining to the first and second products to calculate at least one of a service life, an amount and a cost of material needed to operate each of the first and second products; and
generating a visible display that compares at least one of a service life, an amount and a cost of material needed to operate the first product with at least one of a service life, an amount and a cost of material needed to operate the second product, so as to permit the prospective customer to determine which of the first and second products meets the prospective customer's requirements.

2. The computer implemented method according to claim 1, further comprising the steps of:
changing the data representing expected usage of said first product as changed data input;
processing said changed data input to calculate at least one of a service life, an amount and a cost of material needed to operate the first product in accordance with the changed data input; and
comparing at least one of a service life, an amount and a cost of material needed to operate the first product in accordance with the changed data input with at least one of a service life, an amount and a cost of material needed to operate the first product in accordance with the initial data input.

3. The computer implemented method according to claim 1, wherein the first and second products are absorbent sheet dispensers, and wherein the data representing expected usage of said first product by a prospective customer is at least one of roll length, sheet length, battery capacity, sleep time, awake time and dispense time, and the calculated data output includes battery life for batteries used in the sheet dispenser.

4. A computer-implemented method of comparing a first battery-operated sheet dispenser to a second battery-operated sheet dispenser, comprising the steps of:
inputting into a digital computer plural process parameters for the first battery-operated sheet dispenser;
processing said plural process parameters for the first battery-operated sheet dispenser to determine a first output;
inputting into said digital computer plural processor parameters for the second battery-operated sheet dispenser;
processing said plural process parameters for the second battery-operated sheet dispenser to determine a second output; and
displaying the first output and the second output to provide a user with a comparison so that the user can determine whether the first battery-operated sheet dispenser or the second battery-operated sheet dispenser meets the user's requirements.

5. The computer-implemented method according to claim 4, wherein said inputting plural process parameters for the first battery-operated sheet dispenser comprises inputting at least one of roll length, sheet length, rolls used per years, battery capacity, sleep current, sleep time, awake time.

6. A computer-implemented method of determining which of plural battery-operated sheet dispensers best suit a customer's requirements, comprising the steps of:
inputting plural process parameters for a first one of said plural battery-operated sheet dispensers;
processing said plural process parameters for the first battery-operated sheet dispenser to determine plural first outputs;
inputting plural processor parameters for a second one of said plural battery-operated sheet dispensers;
processing said plural process parameters for the second battery-operated sheet dispenser to determine plural second outputs; and
comparing the first outputs with the second outputs to provide a customer with a real-time comparison of the plural battery-operated sheet dispensers so that the customer can immediately determine which of the plural battery-operated sheet dispensers best meets the customer's requirements.

7. The computer implemented method according to claim 6, wherein said steps of inputting plural process parameters comprises inputting at least one of the following dispenser parameters: a length of a roll of sheets to be dispensed, a length of a sheet to be dispensed, a number of rolls used per year, battery capacity, sleep current, sleep time, awake current, awake time, average dispense current, and dispense time.

8. The computer implemented method according to claim 6, wherein said steps of processing said plural parameters comprise determining an intermediate result of at least one of the following output parameters of a dispenser: a number of sheets per roll, a number of sheets used per month, number of sheets used per day, a number of sheets used per year, energy to dispense one sheet, energy used per month in a standby mode, energy used per month in a dispensing mode, percent of energy used to move sheets, percent of energy used waiting, and average standby current.

9. The computer implemented method according to claim 8, wherein said steps of processing said plural parameters further comprise determining a final result of battery life.

10. A computer implemented method of determining a customer's absorbent sheet dispenser requirements based on a desired maximum frequency of battery replacement, comprising:
inputting into a preprogrammed digital computer data including at least one of 1) a length of a roll of paper towel received by the dispenser; 2) a length of a sheet that is dispensed by the dispenser; 3) a number of rolls used per year; 4) battery capacity of batteries to be used by the dispenser; 5) sleep current; 6) sleep time; 7) awake current; 8) awake time; 9) average dispense current; 10) amp hour ratings of the batteries; and 11) dispense time;
processing said data to determine a projected battery life of at least one said absorbent sheet dispenser.

11. The method as claimed in claim 10, further comprising processing said data to determine how many dispensers are needed in order not to exceed said predetermined maximum frequency of battery replacement.
